(19) United States
(12) Patent Application Publication
(10) Pub. No.: US 2010/0140189 A1
(43) Pub. Date: Jun. 10, 2010

(54) FLUID FILTER

(76) Inventors: Soren Ingemann Jensen, London (GB); Philip McIntyre, Preston (GB)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/294,975

(22) PCT Filed: Mar. 30, 2007
(86) PCT No.: PCT/GB07/01171

§ 371 Date: Feb. 22, 2010

(30) Foreign Application Priority Data
Mar. 31, 2006 (GB) 0606584.1

(51) Int. Cl. B01D 35/10; B01D 35/00; B01D 63/02

(52) U.S. Cl. 210/798; 210/356; 210/321.6; 210/808

(57) ABSTRACT

A fluid filter comprises a filter casing having an inlet end at which a fluid to be filtered is introducible, an and a filtration channel, a plurality of fibres extending longitudinally inside the channel, the fibres being expandable in a direction perpendicular to their length in response to an increase in pressure to create a pinch area between the fibres and an inner surface of the filtration channel.

The present invention relates to a fluid filter, and particularly but not exclusively to a high pressure and throughput filter for removing solid material from a liquid such as water.

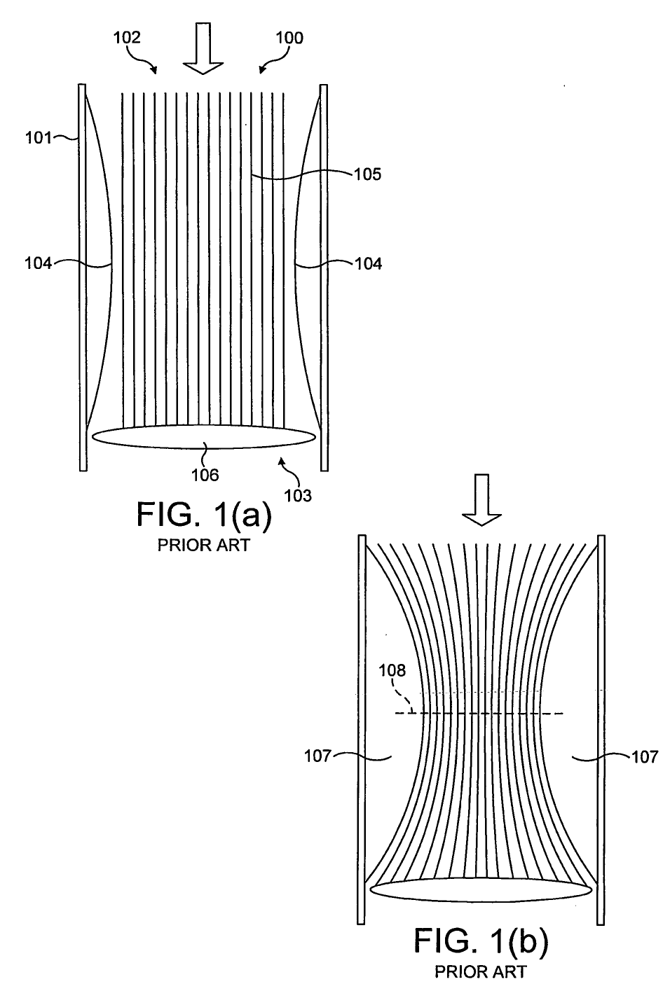

A known filter which makes use of fibres to trap material entrained within the medium is disclosed in EP-A-0280052. The device of EP-A-0280052 is shown in FIGS. 1 and 1a. The filter 100 comprises a filter housing 101 with an inlet end 102 and an outlet end 103. Extending longitudinally of the housing are a plurality of parallel fibres, held in place by a support 106. Surrounding the fibres is a flexible waterproof membrane 104.

During filtration, the membrane 104 is pressurised as shown at 107 in FIG. 1 a using compressed air or the like, thereby compressing the fibres towards an internal pinch point 108. The material to be filtered is forced through the filter in the direction shown by the arrow. The filter may be flushed and cleaned by releasing the pressure within the membrane and back-flushing in the opposite direction to the normal flow of filtration.

In one embodiment, EP-A-0280052 discloses a distensible balloon with fibres surrounding it so that as the balloon is distended using compressed air, the fibres get pushed out against the internal circumference of the filter housing.

This type of filter can work well on a relatively small scale. However, the inflation of the balloon/membrane requires a substantial amount of space and also requires a source of compressed air. The balloon/membrane needs to be long enough to create the graduated filter and this requires fibre length to be long. Thus the component parts of the filter can result in significant expense.

Furthermore, this type of filter can be difficult to apply on a larger scale in which larger volumes of liquid need to be filtered, as the balloon or flexible membrane must be accordingly larger, stronger and will require more compressed air in order to inflate it. The resulting filter can thus be large, awkward and expensive.

It is therefore an aim of the present invention to provide a filter and method of operating a filter that redresses these problems at least to an extent.

According to a first aspect of the present invention, there is provided a fluid filter comprising a filter casing having an inlet end at which a fluid to be filtered is introduced into the filter, an outlet end and a filtration channel, a plurality of fibres extending longitudinally inside the channel, in which the fibres are expandable in a direction perpendicular to their length in response to an increase in pressure inside the fibres to create a pinch area between the fibres and an inner surface of the filtration channel.

An advantage of the filter of claim 1 is that no extra means of compression of the plurality of fibres, such as a balloon or flexible membrane powered by compressed air, is required in order to create an effective filter matrix. This in turn means that the filter can be made smaller or larger as required by a specific application without having to redesign the balloon/membrane and with no need for compressed air for inflation of the balloon/membrane. The filter of the present invention can be housed in a smaller casing than could the prior art filter discussed above for any given requirement of filtration. The filter of the present invention is also cheap to manufacture and easy to install due to the relatively few components.

In an embodiment the fibres may be elastic hollow fibres that are sealed at the outlet end thereof and open at the inlet end thereof.

In an alternative embodiment, the fibres are elastic solid fibres.

The filter may comprise a means of pressurising the fluid to be filtered. In an embodiment, the fluid to be filtered is pressurised to a pressure of 2 bar. At this high pressure, the open end of the hollow fibres experiences the high pressure when the fluid enters the filtration channel, causing the pressure inside the fibres to rise above the pressure in the channel. The elastic fibres thus expand laterally to produce the filter matrix. Where solid fibres are used, the high pressure difference induced along the filter is sufficient to compress the elastic fibres to create a filter matrix.

The filtration channel inner surface may be contoured and/or tapered along the length thereof such that the chamber is restricted in cross-section over at least a portion thereof. This shaping of the channel surface can assist in creating the filter matrix whist the fibres are under pressure when the filter is operating in filtration mode. In this manner, the tightness of packing of the pressurised fibres may gradually vary along the fibre to create a graduated level of filtration. Larger particles may become trapped in the interstices between fibres that are less expanded, whilst smaller particles may become trapped in the interstices between fibres that are more expanded. The means of pressurising the fluid to be filtered may be a pump.

In an embodiment, the inner surface cross-section of the filtration channel may taper gradually along the length thereof. In an alternative embodiment, the inner surface cross-section may taper gradually from the outlet end of the filter casing to a pinch point and gradually re-expand towards the inlet end of the casing. The cross-section may have two or more pinch points. The inner surface of the channel may be untapered. The filtration channel may have a generally circular cross-section or it may have a substantially square rectangular cross-section.

The filter casing may comprise a moulded casing, cast into two parts for ease of manufacture. This construction also enables ease of installation of the fibres within the casing. The fibres may be secured in bundles and may be arranged on a rack inside the filtration channel. The filtration channel may include a recessed portion at the outlet end thereof, in which the fibres are secured. During installation of the filter, the rack or racks can be inserted into the recessed portion of the filtration channel, which is moulded in a first part of the casing. A second part of the casing may comprise a lid which can be secured over the filtration channel to complete the filter casing.

In an embodiment, the filter may include flushing means for flushing the filter in a direction from the outlet end to the inlet end—that is the filter is back flushed. The flushing means may include a vacuum generator that can be used to draw flush liquid out of the filtration channel during the flush mode of the filter.

The filter casing may be elongate and the filtration channel may be elongate. A plurality of racks of fibres can be inserted in series into the elongate filtration channel. This construction has the advantage of increasing the filtration capacity of the filter in a simple and effective manner. The filter may form part of a bank of filters arranged in a housing. The housing may include slots into which the filters are insertable. An advantage of this construction is that if the filter requires replacement, it can be easily removed from the slot in which it is housed and replaced with a new filter.

According to a second aspect of the invention, there is provided a method of operating a filter as set out in the claims.

The invention may be carried out in practice in a number of ways, and several specific embodiments will now be described by way of example, with reference to the accompanying drawings in which:

FIG. 1(a) is a longitudinal section through a prior art filter;

FIG. 1(b) is a longitudinal section through the filter of FIG. 1 in filtration mode;

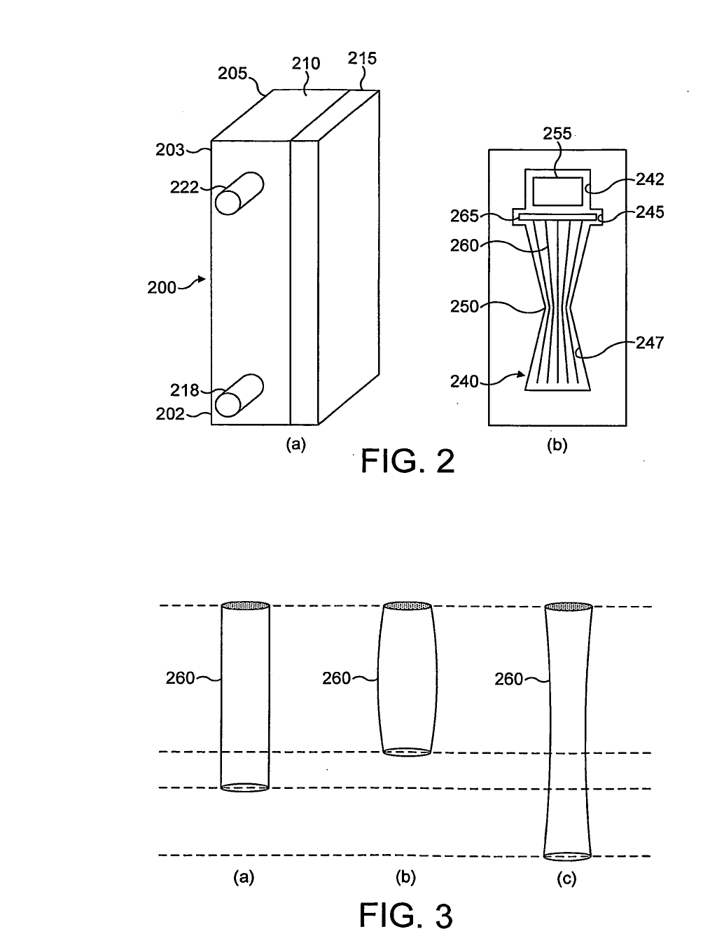

FIG. 2(a) is a schematic perspective view of a filter in accordance with the present invention;

FIG. 2(b) is a longitudinal section through a first embodiment of the present invention;

FIG. 3(a) is a schematic view of a hollow fibre used in the filter of FIG. 2(b);

FIG. 3(b) is a schematic view of the fibre of FIG. 3(a) during a filtration mode of the filter of FIG. 2(b);

FIG. 3(c) is a schematic of the fibre of FIG. 3(a) during a flushing mode of the filter;

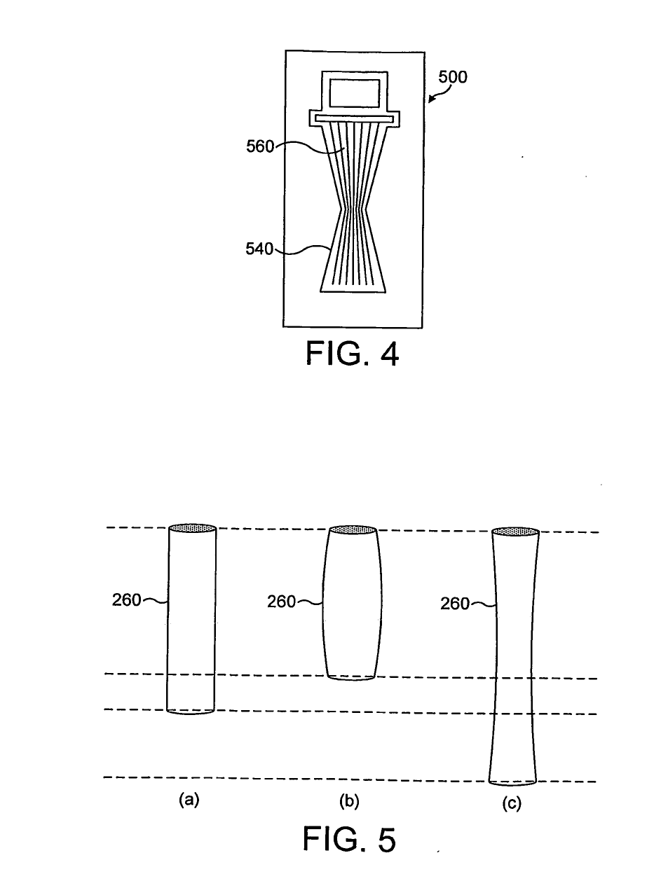

FIG. 4 is a longitudinal section through a second embodiment of the filter;

FIG. 5(a) is a schematic of a solid fibre used in a second embodiment of the filter;

FIG. 5(b) is a schematic of the solid fibre of FIG. 5(a) during a filtration mode of the filter;

FIG. 5(c) is a schematic of the solid fibre of FIG. 5(a) during a flush mode of the filter;

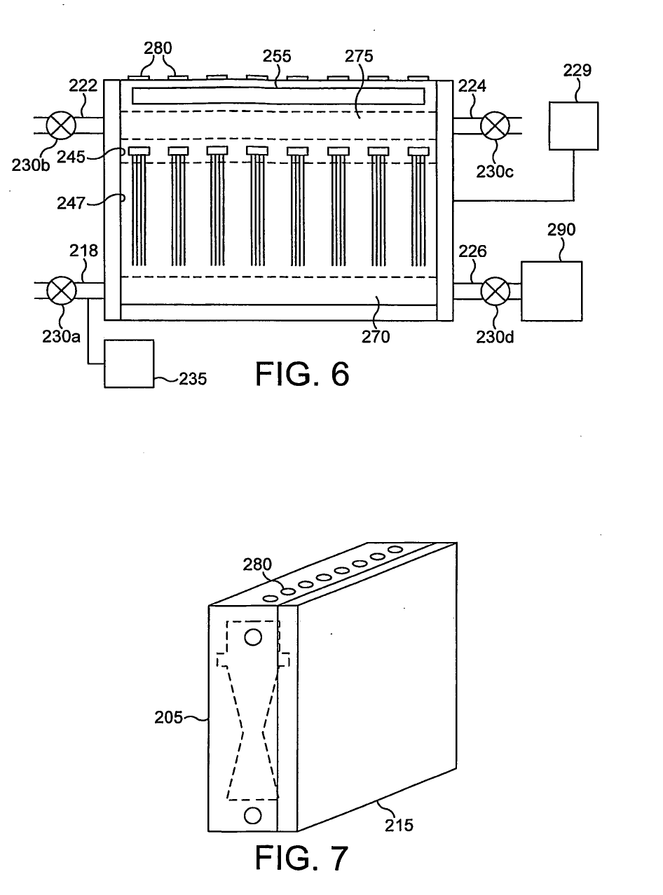

FIG. 6 is longitudinal section through the filter of FIG. 2(a);

FIG. 7 is a schematic perspective view of FIG. 2(a);

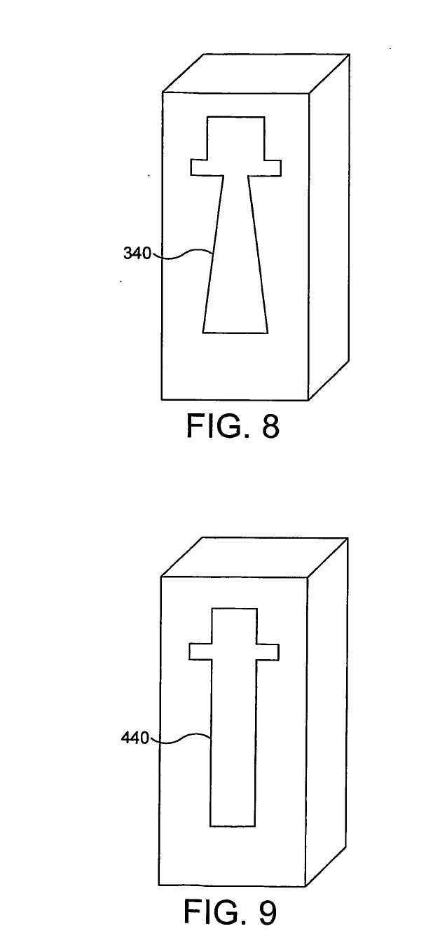

FIG. 8 is a longitudinal section through a further embodiment of the filter having a tapered filtration channel;

FIG. 9 is longitudinal section through a still further embodiment of the filter having a parallel filtration channel;

FIG. 10 is a longitudinal section through a filter according to the first embodiment of the invention, shown in filtration mode;

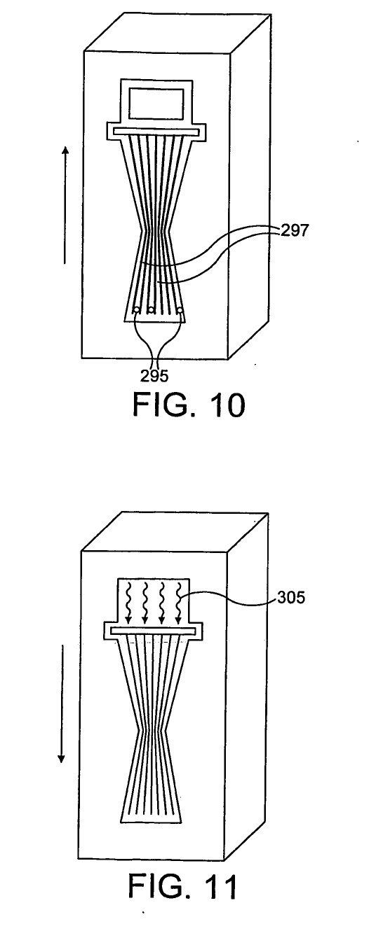

FIG. 11 is longitudinal section through a filter according to the first embodiment of the invention, shown in flush mode;

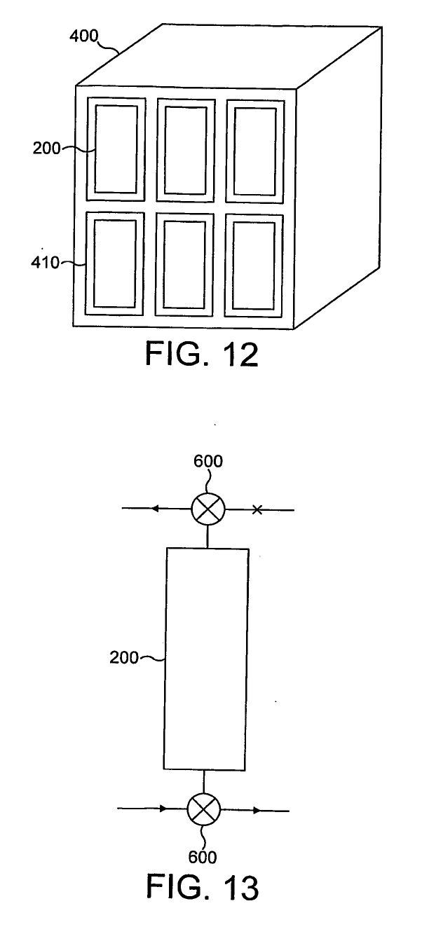

FIG. 12 is a schematic perspective of a bank of filters in accordance with the invention; and

FIG. 13 is a schematic showing an embodiment of the control valves at the inlet end and outlet end of the filter.

Turning firstly to FIG. 2(a) there is shown a filter 200. The filter 200 is contained within a rectangular filter casing 210 the size of which may be selected according to the particular fluid pressure, flow rates or volumes required. The filter casing is preferably made of fibre glass or steel but can be made of another appropriate rigid material. The filter has an inlet end 202 and an outlet end 203 respectively, allowing the medium to be filtered to ingress into and egress from the filter. The filter casing 210 consists of a main first part 205 and a second smaller part 215 that provides a lid for the first part 205. In a specific embodiment the housing has a length of between 300 mm and 500 mm.

At the inlet end 202 an inlet port 218 provides fluid communication into the filter casing 210. At the outlet end 203 an outlet port 222 provides fluid communication from the filter casing. 210 for a filter fluid to further pipes for downstream uses or processing (not shown). Further ports 224, 226 at the opposite face of the casing 210, are seen in FIG. 5 and provide air conduits into and out of the filter casing respectively. Valves 230a, 230b, 230c and 230d are provided in each of the ports 218, 222, 224 and 226 respectively to control the flow rate through each port. A control unit 229 is used to control the valves 230, the operating pressure of the fluid to be filtered and other operational variables of the filter.

FIG. 2(b) shows a longitudinal section of the filter 200, and shows a filtration channel 240 that is cut into the casing 210. The filtration channel 240 extends through the casing 210 and can take various forms as desired. In the present embodiment, the channel 240 includes a rectangular section 242 at the outlet end 203 of the casing 240. Moving towards the inlet end 202, the rectangular section 242 opens out into a shallow recessed portion 245 before the channel reverts briefly back to the width of the rectangular section 242. From here, the channel cross-section gradually narrows with a taper along the walls 247 to a pinch point 250. The channel cross-section is narrowest at the pinch point 250. Beyond the pinch point 250, the channel widens again towards the inlet end 202 at which the channel 240 terminates.

A storage chamber 255 is housed inside the rectangular section 242. The storage chamber 255 is used to store water or other flush liquid or detergents during the filtering mode of the filter.

A plurality of elastic fibres 260 hangs in the channel 240. The fibres are secured in bundles at the outlet end thereof to a rack 265. The rack 265 is housed in the recessed portion 245 of the channel 240. When the filter 200 is not in use, the fibres 260 hang tightly packed in the channel 240 such that they cannot move or can move very little. In this embodiment, the fibres 260 are hollow elastic fibres that are sealed at the outlet end thereof and open at the inlet end as shown in FIG. 3(a). The fibres 260 need not be individually sealed if the manner of securing the fibres at the outlet end effectively provides a seal, such as melting the end together. The fibres 260 may be of any suitable dimension and material, depending upon application. In one example, the fibres may be of polymer or nylon. The fibres can also be made of metal, or they could be plant fibres or made of other natural or organic material. The fibres 260 used in the present embodiment have an overall diameter of 0.1 mm and a length of approximately 300 mm. The fibres may be solid of circular, rectangular or any other cross-section. The fibres may have a smooth or a rough surface and may if required be coated. Fibre coatings such as Teflon and zinc may be appropriate. They may also if desired be electrically charged.

Charging the fibres will encourage ionisation, which may be important in some applications. Also it may be desired for the fluid, the fibres, areas within the housing or any combination of these to be magnetised.

The fibres 260 are flexible and elastic enough such that an increase in pressure inside the fibre will cause it to expand in a direction perpendicular to its length, as shown in FIG. 3(b). The lateral expansion produces a corresponding shortening in the length of the fibre 260. If a negative pressure field is applied around the fibre, and a lower pressure is present inside the fibre that outside the fibre, then the fibre 260 tends to elongate in length and narrow in lateral dimension, as seen in FIG. 3(c).

Referring now to FIG. 6, the filter casing 210 and the filtration channel 240 may be deep enough to allow several racks of fibres 260 to be inserted into the recessed portion 245. The filter 200 seen in FIG. 5 includes eight racks of fibres 260 arranged in series in the channel 240. At the inlet end 202, the casing 210 includes a single fluid inlet port 218 that supplies the fluid to be filtered into a common supply chamber 270 extending the length of the filter casing 210. The casing 210 includes a single outlet chamber 275 for the egress of filtered fluid from the channel 240 to the outlet port 222. A plurality of flush liquid supply ports 280 is arranged in the top face of the filter to enable a flush-to-be supplied to the storage chamber 255.

Air outlet port 226 is connected to a vacuum generator 290 for use in the flushing operation. A pump 235 supplies the required operating pressure to the fluid to be filtered.

The filter 200 is manufactured as follows. The first 205 and second 215 parts of the filter casing 210 are moulded from fibreglass or steel. The first part 205 of the casing 210 includes a major portion of the elongate filtration channel 240 which receives the fibre bundles. The racks of fibre bundles 260 are then inserted into the recessed portion 245 of the channel 240. The second part of the casing 210 consists of the lid 215 which may include contours of the channel 240 formed in an inner surface thereof, as seen in FIG. 7, to complete the cross sectional contouring of the complete filtration channel 240. The lid 215 is sealed over the first part 205 using glue or other appropriate sealing means. The inlet ports 218, 224 and outlet ports 222, 226 are cast with threads for the fitting of the valves 230.

Operation of the filter is as follows. Fluid valves 230a and 230b are opened. The air valves 230c and 230d remain closed during this filtration mode. The fluid to be filtered enters the filter at high pressure at inlet ports 218. In the present embodiments, the fluid is pressured to 2 bar. Thus a pressure difference of Δ2 bar is produced along the filtration channel 240. At this pressure, the open end of the hollow fibres 260 and hence the whole inside of the fibres experiences the high pressure and the pressure inside of the fibres rises relative to the pressure outside the fibres. The fibres 260 thus expand in a direction perpendicular to their length, and their length correspondingly shortens. The expansion of the fibres causes them to tighten together even more closely inside the restricted cross-section area of the filtration channel 240. The fibres 260 are packed most tightly at the pinch point 250 as seen in FIG. 10. The fluid to be filtered filters through the compacted fibres 260 in the direction of the arrow in FIG. 9. Particles in the fluid become trapped in the interstices between the fibres. The larger particles 295 are trapped in the larger interstices and the smallest particles 297 are trapped close to the pinch point 250. Tests have indicated that particles of a size as small as 1 micron can be filtered using this filter.

Once the fluid to be filtered has passed through the filtration channel 240, the filtered fluid exits the filter via outlet port 222.

In an alternative embodiment of the filter 500 shown in FIG. 4, the fibres are elastic solid fibres 560 as seen in FIG. 5(a). In this embodiment, the fibres 560 have a diameter of 0.3 mm, and are identical to the hollow fibres 260 in all other respects.

Operation of this embodiment of the filter 500 is identical to that of the first embodiment of the filter 200. The effect of the introduction of pressurised fluid into the filtration channel 540 is to compress the fibres 560, as shown in FIG. 5(b). As the fibres 560 are elastic, they tend to shorten in length and correspondingly to increase in diameter under the high pressure of the fluid. The increase in diameter of the fibres causes them to tighten together even more closely inside the filtration channel 540 to produce a filter matrix in the interstices between the fibres 560.

The solid fibre filter 500 is suitable for filtering out particles of down to a few microns in size.

The filter 200; 500 is flushed clean as follows. The flushing operation will be described with reference to the first embodiment of the filter 200, for reasons of clarity only, and applies mutatis mutandis to the second embodiment of the filter 500. The filter liquid valves 230a and 230b are closed. The air valves 230c and 230d are then opened simultaneously, introducing a pressure drop inside the filtration channel 240. At this pressure, the pressure inside the fibres 260 drops and becomes lower than the pressure outside of the fibres. Referring to FIG. 11, the fibres elongate and hang more loosely outside the filtration channel, allowing trapped particles 295, 297 to fall from the fibres towards the inlet end. A flushing fluid 305, stored in the storage chamber 255 during the filtering operation, is then released into the filtration channel to rinse the particles 295, 297 from the fibres 260. The flushing liquid 305 exits the filter through port 226 to a further piping system (not shown). As there is no balloon to deflate as in the prior art, the flushing of the filter is quicker and therefore requires less flushing liquid 305.

In an embodiment of the filter, the flush method is enhanced by the vacuum generator 290 as shown in FIG. 6, which includes a small motor (not shown) that is capable of slowly “building up” a vacuum over a period of 10 minutes or so during the filtration mode of the filter. In flush mode, the vacuum generator pulls the flushing liquid out of the filtration channel 240 very quickly. The enhanced flush method described above leaves the particles 295, 297, known as “filter cake” in a drier condition containing a larger percentage of particles, which advantageously requires less downstream processing by the customer.

If it is required, steam can be passed through the filtration channel 240 in order to sterilise the channel 240 and fibres 260.

It will be apparent to the skilled man that the filter can be flushed from either end of the filter depending on the specific construction of the filter.

It will be apparent to the skilled man that the filter of the present invention has several advantages over the prior art filter, including the much reduced likelihood of the fibres becoming tangled because they are packed so tightly and are not free to move inside the filtration channel. The filter casing 210 includes no moving parts and thus shorter fibre bundles can be used in the absence of a balloon/membrane. The net result is that the filter 200 is significantly cheaper to build and to operate than is the prior art filter 100.

Furthermore, the filter has the additional advantage of being able to deliver filtered fluid at a high pressure to a downstream utility. Very often prior art filters cannot operate with a back pressure at the filter outlet, meaning that in order to function properly, the filter outlet pressure must be atmospheric pressure. However, the end use of the filtered fluid may require the fluid to pressurised, for example to mains pressure for use in a washing machine or dishwasher or for being transported through further pipework in an industrial plant.

The prior art filter thus requires an additional pump downstream of the filter in order to supply pressurised filtered fluid to the end user. The additional pump is an extra cost to the customer and also requires additional maintenance and servicing. These disadvantages are removed in the filter of the present application, as the filtered fluid may already be pressurised as it exits the filter without impairing the performance of the filter.

In a further embodiment, a plurality of filters 200 are arranged in banks in a housing 400, see FIG. 12. The housing includes slots 410 into which the filters are inserted.

The filtration channel may have alternative forms, examples of which are seen in FIGS. 8 and 9. In FIG. 8, the filtration channel 340 includes tapered walls that taper inwardly in the direction of filtration, with no mid-way pinch point. In FIG. 9, the walls of the channel 440 are parallel to each other along the length of the channel. It will be apparent that other forms of channel, including one having a rounded cross-section, can be used if desired.

Other variables that can be altered as desired include the diameter and length of the fibres, the dimensions of the casing; the method of manufacture and materials of the casing; the operating pressure, temperature; the manner in which the fibres are anchored. In certain applications, if the fibres are packed tightly enough and the ends of the filtration channel are sealed then the fibres need not be anchored at all. Further variables include flushing materials, volumes and pressures. The filter of the present invention may be scaled in size as desired according to the volumes to be filtered and/or the application in hand. In an embodiment the control valves at the inlet end and outlet end of the filter may be diverter valves such as ball valves as shown in FIG. 13.

Although the filter is shown with its longitudinal axis vertical in the drawings, it will be understood that in some applications the axis may be horizontal.

There are a large number of specific applications which may benefit from the use of a filter according to the present invention. Typical applications might include:
Filtration for reverse osmosis, including for sand, petrol/gas and electrical power plants.
The removal of cement, grit, sand, silica and so on following an industrial process such as precast concrete.
Separation of coagulated products.
Separation of biological tissue.
Separation of coagulated blood and the like.
Separation of vegetable matter, for example the waste water from olive oil production or tomato waste.
Reducing the turbidity of water generally, where require for technical or for legal reasons.
The removal of silt from a liquid/water.
Ballast water.
Removal of chemicals.

1. A fluid filter comprising a filter casing having an inlet end at which a fluid to be filtered is introducible, an outlet end and a filtration channel, a plurality of fibres extending longitudinally inside the channel, whereby the fibres are expandable in a direction perpendicular to their length in response to an increase in pressure to create a pinch area between the fibres and an inner surface of the filtration channel.

2. A fluid filter as claimed in claim 1 in which the fibres are elastic hollow fibres that are sealed at the outlet end thereof and open at the inlet end thereof.

3. A filter as claimed in claim 1 in which the fibres are elastic solid fibres.

4. A filter as claimed in claim 1 or claim 2 or claim 3, further comprising a means of pressurising the fluid to be filtered.

5. A filter as claimed in claim 4 in which the means is a pump.

6. A filter as claimed in claim 4 or claim 5 in which the fluid is pressurised to a pressure of approximately 2 bar during a filtration mode of the filter.

7. A filter as claimed in any preceding claim in which the filtration channel inner surface is contoured and/or tapered along the length thereof such that the channel is restricted in cross section over at least a portion thereof.

8. A filter as claimed in claim 7 in which the cross section of the filtration channel narrows gradually along the length thereof.

9. A filter as claimed in claim 7 in which the filtration channel cross section tapers gradually from the outlet end to a pinch point and gradually re-expands towards the inlet end thereof.

10. A filter as claimed in claim 9 in which the filtration channel includes two or more of the pinch points.

11. A filter as claimed in any preceding claim in which the filtration channel has a generally square or rectangular cross section.

12. A filter as claimed in any of claims 1 to 10 in which the filtration channel has a generally circular cross section.

13. A filter as claimed in any preceding claim in which the filter casing comprises a moulded casing having first and second parts.

14. A filter as claimed in claim 13 in which the first part comprises the filtration channel, and the second part comprises a lid for covering the channel of the first part.

15. A filter as claimed in any preceding claim in which the fibres are secured in bundles at the outlet end of the filter.

16. A filter as claimed in claim 15 in which the fibre bundles are arranged on a rack inside the filtration channel.

17. A filter as claimed in any preceding claim in which the filtration channel includes a recessed portion at the outlet end thereof at which the fibres are secured.

18. A filter as claimed in any preceding claim, further comprising a control valve for controlling the supply of the fluid to be filtered into the filter.

19. A filter as claimed in any preceding claim in which the filter casing includes a flush liquid storage chamber at the outlet end thereof.

20. A filter as claimed in any one of the preceding claims including flushing means for flushing the filter in a direction from the outlet end to the inlet end.

21. A filter as claimed in claim 19 in which the flushing means includes a vacuum generator.

22. A method of operating a filter having a filter casing with a first end and a second end, a filtration channel and a plurality of fibres extending longitudinally of the filtration channel; the method comprising passing a supply of pressurised fluid to be filtered from the second end to the first end causing the fibres to expand in a direction perpendicular to their length creating a filter matrix between the fibres and an inner surface of the filtration channel.

23. A method as claimed in claim 22 in which the fibres are elastic hollow fibres that are sealed at the first end thereof and open at the second end thereof, and wherein the step of passing of the fluid to be filtered from the second end to the first end causes an increase in pressure inside the fibres above the pressure in the filtration channel.

24. A method as claimed in claim 22 in which the fibres are elastic solid fibres.

25. A method as claimed in claim 22 in which the fluid is pressurised to a pressure of 2 bar.

26. A method as claimed in any of claims 22 to 25, including the step of flushing the filter by closing off the supply of pressurised fluid into the filter and passing a flushing fluid from the first end to the second end.

27. A method as claimed in any of claims 22 to 26 including the step of passing steam and/or a cleaning chemical through the filtration channel to clean the fibres.

28. A method as claimed in any of claims 22 to 27 in which a vacuum generator is provided at the second end thereof, and wherein the step of flushing further comprises operating the vacuum generator to draw the flushing liquid out of the filtration channel.
